(19) United States
(12) Patent Application Publication
(10) Pub. No.: US 2012/0298587 A1
(43) Pub. Date: Nov. 29, 2012

(54) FLUID TREATMENT SYSTEM

(75) Inventor: Wade R. Bozak, Edmonton (CA)

(73) Assignee: RJ OIL SANDS INC., New Westminster, BC (CA)

(21) Appl. No.: 13/521,723

(22) PCT Filed: Jan. 11, 2011
(86) PCT No.: PCT/CA2011/050008

§ 371 Date: Jul. 11, 2012

Related U.S. Application Data
(60) Provisional application No. 61/294,064, filed on Jan. 11, 2010.

(30) Foreign Application Priority Data
Jan. 11, 2010 (CA) 2689729

(51) Int. Cl. B01D 17/035; B01F 5/12; B03D 1/00; B01D 21/01; F17D 1/00; B01D 37/00

(52) U.S. Cl. 210/703; 137/3; 210/806; 210/723; 261/2

(57) ABSTRACT

A fluid treatment device and method is proposed for the treatment of a fluid that has components to be separated, such as tailings. The fluid treatment device in one embodiment comprises a motive pump connected to drive fluid to be treated along a conduit through a restriction forming a nozzle into a mixing chamber and thence to a discharge. A port, which may be controlled by a valve, admits gas into an initial portion of the mixing chamber. The motive pump, nozzle, gas port and mixing chamber together form a phase separator. Multiple phase separators may be connected together in series. The mixing chamber may have constant diameter and a length to diameter ratio of 20:1 or 60:1 or more. The conduit terminates in a discharge. The discharge may supply the treated fluid to a secondary separation device such as a flotation cell. Solids and liquids may be taken off the flotation cell for disposal, further processing or delivery into a sales line.

### BACKGROUND

Field: treatment of tailings, for example tailings from tailings ponds resulting from oil sands production. In oil sands production, bitumen may be extracted from a mixture that is approximately 10% bitumen, 80% sand, and 10% fine tailings. The fine tailings are generally deposited in a tailings pond. However, fine tailings will not fully settle in these tailing ponds. It is believed that the electrostatic interactions between the suspended particles, which are still partly contaminated with hydrocarbons, prevent this from occurring. These tailing ponds have become an environmental liability for the companies responsible.

The oil sands tailings ponds constitute an unanticipated but persistent environmental and economic problem. They reflect process deficiencies in the bitumen extraction methods currently used. The problem has been mitigated by the industries to some degree, but there are several ponds that still present a major challenge for reclamation. Recent studies have been published that address the treatment of tailings as they are produced, in order to avoid the need for the large settling and storage areas.

### SUMMARY

A fluid treatment device and method is proposed for the treatment of a fluid that has components to be separated, such as tailings. The fluid treatment device in one embodiment comprises a motive pump connected to drive fluid to be treated along a conduit through a restriction forming a nozzle into a mixing chamber and thence to a discharge. A port, which may be controlled by a valve, admits gas into an initial portion of the mixing chamber. The motive pump, nozzle, gas port and mixing chamber together form a phase separator. The mixing chamber is preferably sized intermediate in diameter between the restriction and the conduit upstream of the restriction. Multiple phase separator s may be connected together in series. The mixing chamber may have constant diameter and a length to diameter ratio of 20:1 or 60:1 or more. The conduit terminates in a discharge. The discharge may supply the treated fluid to a secondary separation device such as a flotation cell. Solids and liquids may be taken off the flotation cell for disposal, further processing or delivery into a sales line. In another embodiment, the fluid to be treated is injected into motive fluid exiting the restriction through a port in the conduit upstream of the mixing chamber.

### BRIEF DESCRIPTION OF THE DRAWINGS

Exemplary embodiments are now described in detail with reference to the drawings, in which:

FIG. 1 is a schematic showing an exemplary fluid treatment device.

FIG. 2 is a detailed schematic, not to scale, of a device for use in the process of FIG. 1.

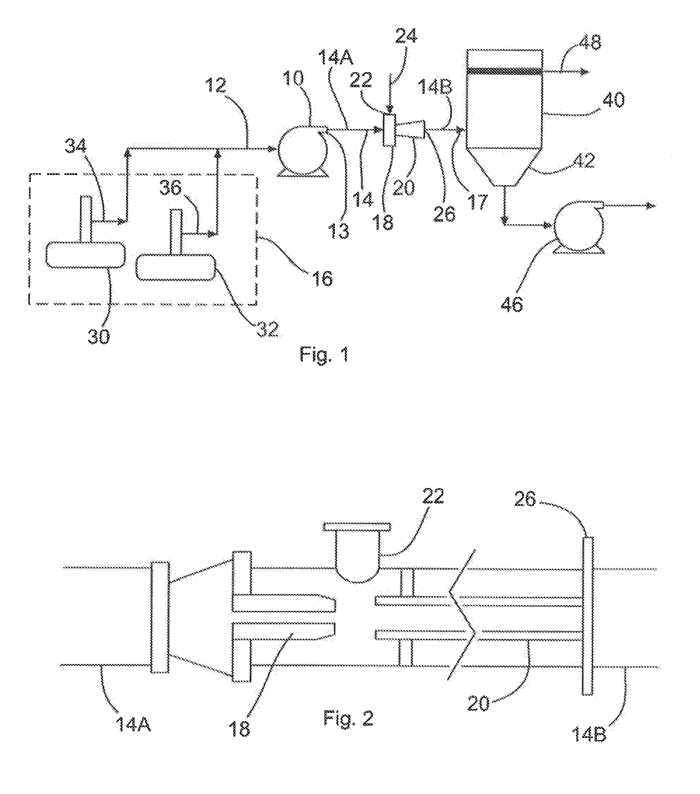

### DETAILED DESCRIPTION OF THE DRAWINGS

Tailings may contain primarily both hydrocarbons and solids, for example mineral material, such as rock, sand, silt and clay. Because of the hydrocarbon contamination of the tailings stored in tailings ponds, the process below is particularly useful in reclaiming these ponds by removing the contamination, and using the decontaminated tailings to return land to its natural state. However, the apparatus and method may also be applied to any fluid having components to be separated, such as an oil-water mixture, oil-solid mixture, or oil-water-solid mixture. The fluid to be treated may comprise tailings from deep within a tailings pond, without dilution, so long as the tailings are pumpable. If the tailings are not pumpable, they may be made pumpable by dilution with water.

A fluid treatment device comprises a motive pump 10 having an inlet 12 and an outlet 13. The inlet 12 is connected to a source 16 of fluid having components to be separated. A conduit 14 connected to the outlet 13 of the motive pump 10. The conduit 14 has a discharge 17. A restriction 18 in the conduit 14 forms a nozzle through which the fluid flows when the motive pump 10 is operated. The restriction 18 divides the conduit 14 into an upstream end 14A between the motive pump 10 and nozzle 18 and a downstream end 14B that terminates at the discharge 17. The conduit 14 has a mixing chamber 20 downstream of the nozzle 18 and a port 22 for admission of gas 24 into the mixing chamber 20 in an initial portion of the mixing chamber 20. The motive pump 10, restriction 18, mixing chamber 20 and port 22 together comprise a phase separator.

In the example shown, the mixing chamber 20 terminates downstream at a transition 26 in the conduit 14B to a larger diameter portion of the conduit 14 and the mixing chamber 20 has a length to internal diameter ratio of at least 20:1 or 40:1, preferably in the range 50:1 to 60:1. Improved separation of the fluid components has been found to occur as the length to internal diameter of the mixing chamber 20 increases from 20:1 to 60:1. For example, by comparison with a conventional jet pump under the same testing conditions, a jet separator of the type disclosed here with a mixing chamber having a 40:1 length to diameter ratio (actual diameter: 43 mm) had an approximately 40% higher mass production of froth during treatment of oil sands tailings. The conventional jet pump had a mixing chamber with a length to diameter ratio of approximately 5:1 and actual diameter 44 mm. By same test conditions is meant: same feed material, same diameter piping on either side of the jet separator/jet pump, same flow rate and same pressure. The only difference, other than the minor difference in mixing chamber diameter between the two set ups, was the replacement of the jet separator described here with a conventional jet pump. The inventor has found that improved performance in terms of froth generation is obtained from a jet separator when the mixing chamber has a length to diameter ratio larger than a conventional jet pump, which the inventor understands to have a mixing chamber with a length to diameter ratio of less than 20:1. Large improvements in the effectiveness of the mixing chamber 20 have not been measured for length to internal diameter ratios greater than 60:1.

The mixing chamber 20 preferably has constant internal diameter along the length of the mixing chamber 20. When the mixing chamber 20 does not have constant internal diameter, the internal diameter of the mixing chamber 20, for the purpose of calculating the length to internal diameter ratio, is the mean internal diameter. The internal diameter of the mixing chamber 20 should be selected so that the fluid exiting the restriction 18 undergoes turbulence and collision with all parts of the internal wall of the mixing chamber 20. The mixing chamber 20 need only begin after the fluid exiting the restriction 18 has expanded sufficiently to contact the walls of the mixing chamber 20. Although the phase separator does not pump anything other than air from the port 22, it has the general design of a jet pump in terms of the relationship of the size of the mixing chamber to the restriction.

The port 22 should be located downstream of the restriction 18 and before the mixing chamber 20. The conduit 14 immediately after the restriction 18 should have a diameter sufficient to accommodate the jet exiting the restriction 18. The mixing chamber 20 should have an internal diameter that is less than internal diameter of the conduit 14A (before the restriction 18) and greater than the diameter of the restriction 18. Hence, if the conduit 14A is a 16 inch pipe, and the restriction is 6 inches, then the mixing chamber may have an internal diameter between 6 inches and 16 inches, for example 12 inches. For a 12 inch internal diameter mixing chamber 20, the mixing chamber 20 may be 40 feet long. For treatment of tailings, the diameter of the restriction 18 is selected to provide a pressure in the conduit 14A before the restriction 18 of 75 psi to 150 psi. The conduit 14 after the transition 26 may have an internal diameter equal to the internal diameter of the upstream portion 14A of the conduit 14.

The fluid having components to be treated may comprise tailings from a tailings pond, such as a tailings pond at a heavy oil mining facility. In an example, the fluid source 16 may comprise a first submersible pump 30 connected to pump fluid from a first portion of a tailings pond and a second submersible pump 32 connected to pump fluid from a second portion of a tailing pond. The pumps 30, 32 respectively have outlets 34, 36 connected to the inlet 12 of the motive pump 10.

The pump 32 may be deeper in the tailings pond than the pump 30 so that the weight percent of solids of fluid in the first portion of the tailings pond is less than the weight percent solids of fluid in the second portion of the tailings pond.

The port 22 preferably comprises a valve, which may be controlled manually or automatically. When the port 22 is not open, a vacuum created in the conduit 14 downstream of the pump 10 causes vibration within the pipe and poor separation of the fluid components. When the port 22 is opened sufficiently for the vibration to stop, the fluid components are agitated and a phase separation occurs within the fluid so that oil is stripped from solids. Gas, for example air, introduced through the port 22 becomes entrained with the fluid components and tends to adhere to oil in the fluid.

The discharge 17 is disposed to discharge treated fluid into a secondary separation apparatus such as a flotation tank 40. Other secondary separation apparatus may be used, such as a centrifuge, hydro-cyclone or another fluid treatment apparatus comprising an additional motive pump 10, restriction 18, mixing chamber 18 and port 22. Any number of additional such secondary apparatus may be used as necessary to effect an adequate phase separation. Thus, the fluid treatment device may comprise series connected combinations of motive pump 10, restriction 18, mixing chamber 18 and port 22 together connected between a source of fluid 16 and a secondary separation apparatus such as flotation tank 40.

A slightly wet solid phase may be extracted from conical base 42 of flotation tank 40 via line 44 and pump 46. The wet solids may be allowed to dry or dried in various ways, such as with the addition of heat, but may also be allowed to drain. Once dried, the solids may be returned to a reclaimed mine site or subject to further processing, for example to extract minerals from the solids. Exemplary minerals that may be extracted include gold and titanium. Oil may be extracted from the tank 40 for example by spillover or skimming at line 48. The oil may be delivered to a pipeline or subject to further processing. Addition of gas 24 at the port 22 facilitates flotation of oil in the flotation tank 40.

The disclosed fluid treatment devices operates by pumping fluid using the motive pump 10 through the restriction 18 in the conduit 14 into the mixing chamber 20 downstream of the restriction 18. Gas is added into the fluid downstream of the restriction 18 in an initial portion of the mixing chamber 20. The fluid is discharged from the conduit 14 for example into a secondary treatment device such as the flotation tank 40.

In a further embodiment, the fluid having components to be separated, such as tailings, may be supplied to the mixing chamber 20 through the port 22 from a source of the fluid such as from one of the pumps 30, 32. Motive fluid to be pumped by pump 10 may be water, for example supplied from a portion of a tailings pond through the other of pumps 30, 32. The port 22 may comprise one or more openings in the conduit downstream of the restriction 18 but upstream of the mixing chamber 20. If more than one opening is used, gas, for example air, may be supplied through one opening and the fluid to be treated through another opening. As many openings may be used as required. Flow through the port 22 may be regulated by a valve or valves. The term opening is used here to denote a port. While air may be injected simply through the valve, a further conduit leading to a source of the fluid that is being treated is required for the delivery of fluid to the port 22.

When a flotation cell 40 is used to receive fluid from the discharge 17, the flow into the cell 40 is preferably gently dispersed into the flotation cell without vigorous contact with the fluid already in the flotation cell 40. To allow for gentle dispersion of the treated fluid from the discharge 17 into the cell 40, a fan-like diffuser plate may be used to spread the treated fluid on the surface of the flotation cell or the fluid may flow across a gentle sloping pan before flowing into fluid already in the flotation cell 40.

Immaterial modifications may be made to the embodiments described here without departing from what is covered by the claims.

1. A fluid treatment device, comprising:
a motive pump having an inlet and an outlet, the inlet being connected to a source of fluid having components to be separated;
a conduit connected to the outlet of the motive pump, the conduit having a discharge;
a restriction in the conduit forming a nozzle through which the fluid flows when the motive pump is operated, the restriction dividing the conduit into an upstream end between the motive pump and nozzle and a downstream end that terminates at the discharge; and
the conduit having a mixing chamber downstream of the nozzle and a port for admission of gas into the mixing chamber in an initial portion of the mixing chamber, in which the mixing chamber has a length to internal diameter ratio of at least 20:1 and at most 60:1.

2. The fluid treatment device of claim 1 in which the mixing chamber has a mixing chamber internal diameter, the restriction has a restriction diameter and the upstream end of the conduit has a conduit internal diameter and the mixing chamber internal diameter is sized between the restriction diameter and the conduit internal diameter.

3. The fluid treatment device of claim 2 in which the mixing chamber terminates downstream at a transition in the conduit to a larger diameter portion of the conduit.

4. The fluid treatment device of claim 3 in which the mixing chamber has constant internal diameter along the length of the mixing chamber.

5. The fluid treatment device of claim 2 in which the mixing chamber terminates downstream at a transition in the conduit to a larger diameter portion of the conduit and the mixing chamber has a length to internal diameter ratio of at least 40:1.

6. The fluid treatment device of claim 5 in which the mixing chamber has constant internal diameter along the length of the mixing chamber.

7. The fluid treatment device of claim 1 in which the fluid comprises an oil and water mixture.

8. The fluid treatment device of claim 7 in which the fluid comprises an oil, water and solids mixture.

9. The fluid treatment device of claim 8 in which the fluid comprises tailings from a tailings pond.

10. The fluid treatment device of claim 9 in which the source of fluid comprises a first pump connected to pump fluid from a first portion of a tailings pond and a second pump connected to pump fluid from a second portion of a tailing pond, the first pump and the second pump each having outlets connected to the inlet of the motive pump.

11. The fluid treatment device of claim 10 in which the first portion of the tailings pond comprises a first weight percent of solids and the second portion of the tailings pond comprises a second weight percent of solids and the second weight percent is less than the first weight percent.

12. The fluid treatment device of claim 1 in which the port comprises a valve.

13. The fluid treatment device of claim 1 in which the discharge is disposed to discharge treated fluid into a secondary separation apparatus.

14. The fluid treatment device of claim 13 in which the secondary separation apparatus comprises a flotation tank.

15. A method of treating a fluid, comprising:
pumping fluid using a motive pump through a restriction in a conduit into a mixing chamber downstream of the restriction, the fluid having components to be separated;
adding gas into the fluid downstream of the restriction in an initial portion of the mixing chamber, in which the mixing chamber has a length to internal diameter ratio of at least 20:1 and at most 60:1; and
discharging the fluid from the conduit.

16. The method of claim 15 in which the mixing chamber has a mixing chamber internal diameter, the restriction has a restriction diameter and the upstream end of the conduit has a conduit internal diameter and the mixing chamber internal diameter is sized between the restriction diameter and the conduit internal diameter.

17. The method of claim 16 in which the mixing chamber terminates downstream at a transition in the conduit to a larger diameter portion of the conduit.

18. The method of claim 16 in which the mixing chamber terminates downstream at a transition in the conduit to a larger diameter portion of the conduit and the mixing chamber has a length to internal diameter ratio of at least 40:1.

19. The method of claim 17 in which the mixing chamber has a constant internal diameter along its length.

20. The method of claim 15 in which the fluid comprises an oil and water mixture.

21. The method of claim 20 in which the fluid comprises an oil, water and solids mixture.

22. The method of claim 21 in which the fluid comprises tailings from a tailings pond.

23. The method of claim 22 further comprising supplying fluid to the motive pump from the tailings pond by pumping fluid from a first portion of the tailings pond and pumping fluid from a second portion of the tailing pond.

24. The method of claim 23 in which the first portion of the tailings pond comprises a first weight percent of solids and the second portion of the tailings pond comprises a second weight percent of solids and the second weight percent is less than the first weight percent.

25. The method of claim 15 in which adding gas into the fluid comprises metering the gas through a valve.

26. The method of claim 15 in which treated fluid is discharged into a secondary separation apparatus for further separation of fluid components.

27. The method of claim 26 in which the secondary separation apparatus comprises a flotation tank, and treated fluid is discharged into the flotation tank with dispersion of the treated fluid across the surface of fluid in the flotation tank.

28. The method of claim 25 further comprising enhancing separation in the secondary separation apparatus by adding a flocculent.

29-38. (canceled)

39. A fluid treatment device, comprising:
a motive pump having an inlet and an outlet, the inlet being connected to a source of motive fluid;
a conduit connected to the outlet of the motive pump, the conduit having a discharge;
a restriction in the conduit forming a nozzle through which the motive fluid flows when the motive pump is operated, the restriction dividing the conduit into an upstream end between the motive pump and nozzle and a downstream end that terminates at the discharge;
the conduit having a mixing chamber downstream of the nozzle and at least a port in an initial portion of the mixing chamber for admission into the mixing chamber of gas and a fluid having components to separated;
the mixing chamber having a mixing chamber internal diameter;
the restriction having a restriction diameter;
the upstream end of the conduit having a conduit internal diameter and the mixing chamber internal diameter is sized between the restriction diameter and the conduit internal diameter;
the mixing chamber terminating downstream at a transition in the conduit to a larger diameter portion of the conduit and the mixing chamber having a length to internal diameter ratio of at least 20:1 and at most 60:1.

40. The fluid treatment device of claim 39 in which the mixing chamber has constant internal diameter along the length of the mixing chamber.

41. The fluid treatment device of claim 40 in which the mixing chamber has a length to internal diameter ratio of at least 40:1.

42. The fluid treatment device of claim 39 in which the fluid having components to be separated comprises an oil and water mixture.

43. The fluid treatment device of claim 42 in which the fluid having components to be separated comprises an oil, water and solids mixture.

44. The fluid treatment device of claim 43 in which the fluid comprises tailings from a tailings pond.

45. The fluid treatment device of claim 39 in which the source of motive fluid comprises a first pump connected to pump fluid from a first portion of a tailings pond and the port is supplied with a fluid having components to be separated through a second pump connected to pump fluid from a second portion of a tailings pond.

46. The fluid treatment device of claim 1 in which the discharge is disposed to discharge treated fluid into a secondary separation apparatus.

47. The fluid treatment device of claim 13 in which the secondary separation apparatus comprises a flotation tank.

48. A method of treating a fluid, comprising:
pumping fluid using a motive pump through a restriction in a conduit into a mixing chamber downstream of the restriction, the fluid having components to be separated; and
discharging a treated fluid from the conduit into a flotation tank with dispersion of the treated fluid across the surface of fluid in the flotation tank.

49. A method of treating a fluid, comprising:
combining a first fluid, having a first weight percent of solids, with a second fluid, having a second weight percent of solids, to produce combined fluid, in which the first weight percent of solids is less than the second weight percent of solids;
pumping the combined fluid using a motive pump through a restriction in a conduit into a mixing chamber downstream of the restriction, the combined fluid having components to be separated; and
discharging the combined fluid from the conduit.

50. The method of claim 49 in which the first fluid and the second fluid are from one or more tailings ponds.
